(19) United States
(12) Patent Application Publication
(10) Pub. No.: US 2025/0261770 A1
(43) Pub. Date: Aug. 21, 2025

(54) GROW TRAY AND STAND ASSEMBLY FOR SUPPORTING GROWING PLANTS

(71) Applicant: FOHSE INC., Las Vegas, NV (US)

(72) Inventors: Alex Gerard, Rogers, MN (US); Michael Howard, JR., Las Vegas, NV (US)

(21) Appl. No.: 19/057,267

(22) Filed: Feb. 19, 2025

Related U.S. Application Data
(60) Provisional application No. 63/555,493, filed on Feb. 20, 2024.

(51) Int. Cl. A47G 7/04; A01G 22/00

(52) U.S. Cl. CPC A47G 7/041; A01G 22/705

(57) ABSTRACT

A grow tray for supporting one or more plants has a bottom, an upwardly extending peripheral rim, and at least one drain and is defined by a plurality of associable tray segments, such as four, where each tray segment defines a portion of the bottom of the tray and at least one side defining a portion of the upwardly extending peripheral rim, a plurality of supports extending upwardly from the bottom and one or more channels defined between the supports. A stand apparatus for a grow tray has legs which support disconnectable raised beams, and a central support having a central mount which is supported by cross-supports which extend between the central mount and the beams.

### RELATED APPLICATION DATA

The present application claims priority to U.S. Provisional Application Ser. No. 63/555,493, entitled “GROW TRAY AND STAND ASSEMBLY FOR SUPPORTING GROWING PLANTS,” filed on Feb. 20, 2024, which is incorporated herein by reference in its entirety.

### FIELD OF THE INVENTION

The present invention relates to plant grow stands.

### BACKGROUND OF THE INVENTION

Support assemblies for plant growing, such as used to assist in growing cannabis, are known. Known support assemblies commonly include a stand and a tray coupled to, supported by, and/or provided with the stand, wherein the plants are configured to be located on and grow on the raised tray. In today's art, the plant or grow trays are generally made from a single piece of material, which makes them expensive to manufacture and ship, and difficult to install and/or replace. Similarly, known stands are generally unitary elements which are large and expensive to ship and store, are not repairable, and do not always have a design which is compatible for supporting a selected plant or grow tray.

It is with respect to these and other considerations that the instant disclosure is concerned.

### SUMMARY OF THE INVENTION

Aspects of the invention comprise a grow tray, such as for supporting one or more plants, and a stand apparatus, such as for supporting a grow tray in a raised position.

In one embodiment, a grow tray for supporting one or more plants has a bottom, an upwardly extending peripheral rim, and at least one drain. The grow tray is defined by a plurality of associable tray segments, where each tray segment defines a portion of the bottom of the tray and has at least one side defining a portion of the upwardly extending peripheral rim, a plurality of supports extending upwardly from the bottom and one or more channels defined between the supports. In one embodiment, the grow tray has four sides and is constructed from four tray segments, such as each defining a corner segment of the tray.

A stand apparatus for a grow tray has legs which support disconnectable raised beams, and a central support which comprises a central mount which is supported by cross-supports which extend between the central mount and the beams.

In combination, the grow tray of the invention may be placed on the central support of the stand apparatus so as to be supported in a raised position. In one configuration, a flange which extends outwardly from the rim of the tray overlaps a top of the raised beams of the stand, and a central drain of the tray is aligned with an opening in the central mount.

Both the tray and stand apparatus may be disassembled into a configuration of reduced dimension for shipping and storage. In one embodiment, both the tray and stand apparatus can be assembled and disassembled without the use of tools.

Further objects, features, and advantages of the present invention over the prior art will become apparent from the detailed description of the drawings which follows, when considered with the attached figures.

### DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIGS. 1 and 2 are isometric views of a support assembly for growing plants, with FIG. 2 shown with a portion of a tray removed in order to see hidden structures.

FIG. 3 is an isometric bottom view of the tray for the support assembly of FIGS. 1 and 2.

FIG. 4 is an isometric top view of the tray illustrated in FIG. 3 with a segment thereof removed.

FIGS. 5A and 5B are top and bottom isometric views of a segment of the tray of FIGS. 3 and 4.

FIGS. 6 and 7 are different exploded isometric views of portions of a stand apparatus for the support assembly of FIGS. 1 and 2.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

As employed herein, the term “coupled” shall mean connected together either directly or via one or more intermediate parts or components.

As employed herein, the term “number” shall mean one or an integer greater than one (i.e., a plurality).

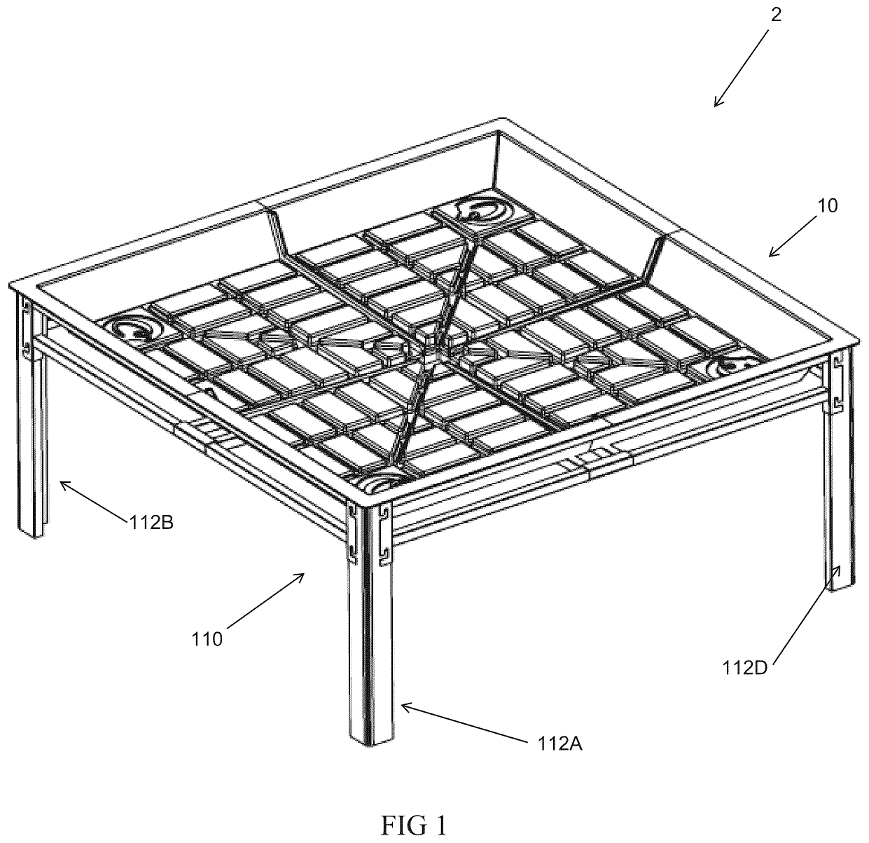

FIG. 1 shows an isometric view of a plant support assembly 2. As shown, the support assembly 2 includes a grow tray 10 and a stand apparatus 110 configured for supporting the tray 10 in a raised position. It will be appreciated that the tray 10 may be configured to support plants (such as in soil in the tray or in soil in a pot or other container located on the tray), such as cannabis, during growing, and the stand apparatus 110 may be configured to support the tray 10 at an elevation above the ground or another support surface.

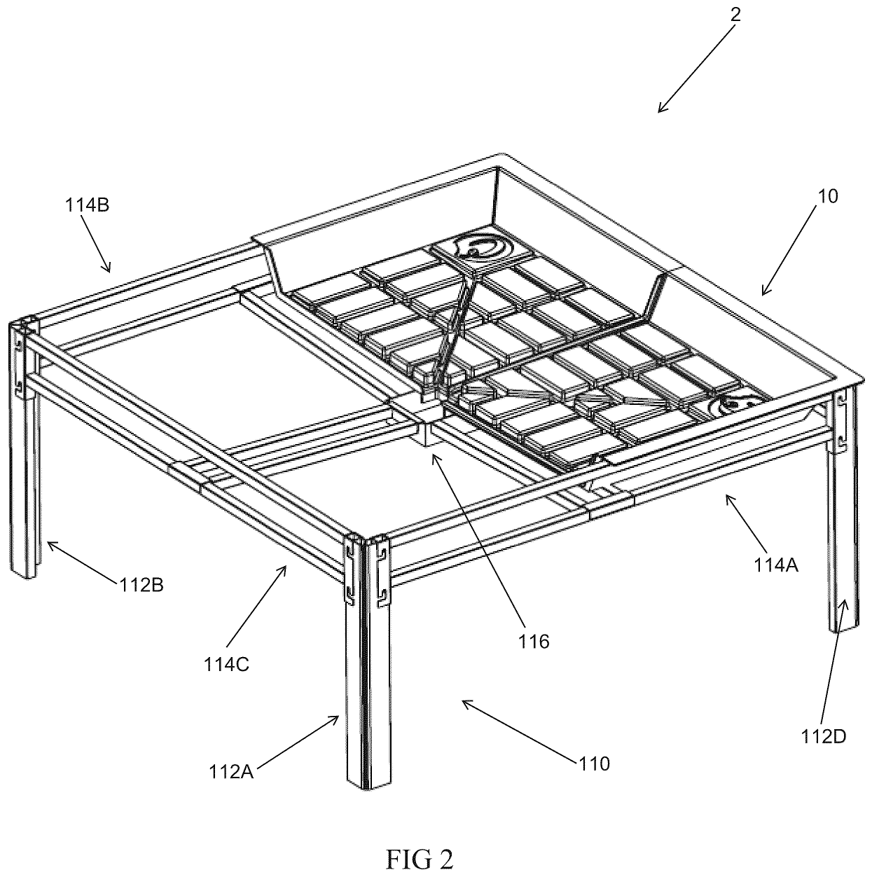

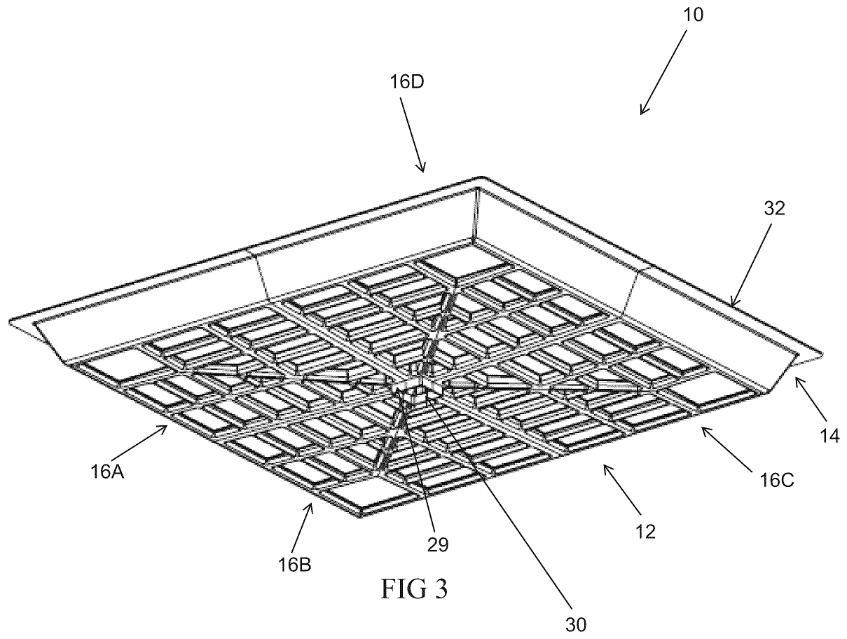

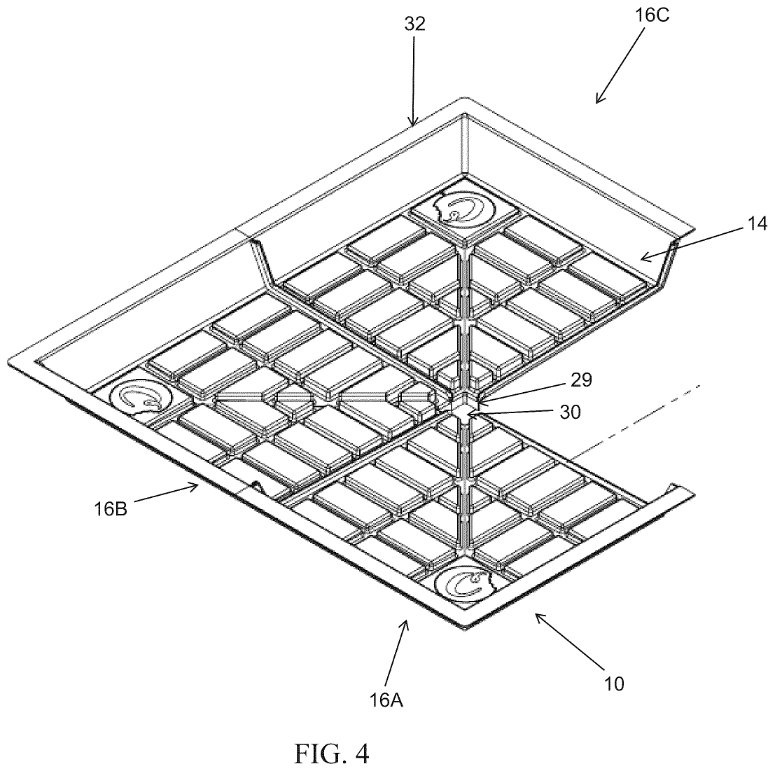

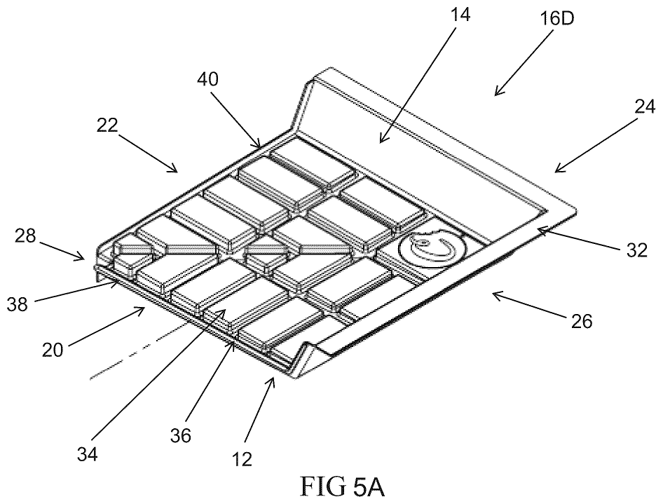

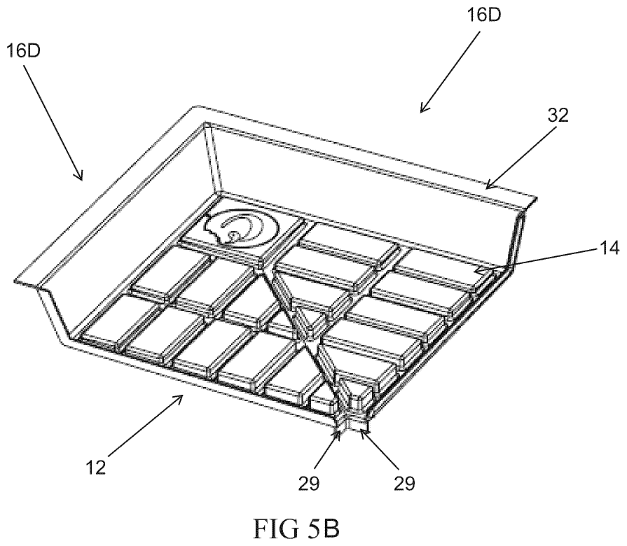

FIG. 2 shows another isometric view of the plant support assembly 2 and is shown with a portion of the tray 10 removed. FIG. 3 shows a bottom view of the tray 10 as assembled, FIG. 4 shows a top view of the tray 10 with a segment thereof removed, and FIGS. 5A and 5B are top and bottom views of one of the tray segments.

In general, when assembled, the tray 10 has a bottom 12 and a periphery which is generally defined by an upwardly extending rim 14 (the rim thus positioned at an elevation above the bottom). The rim 14 may extend generally perpendicular to the bottom 12 of the tray 10, including sloping slightly beyond vertical (whereby the peripheral dimension of the rim 14 exceeds that of the bottom 12). The size and shape of the tray 10 may vary, such as being generally square, rectangular, circular, or even other shapes. In one preferred embodiment, the tray 10 is generally square in overall peripheral shape.

In one embodiment, the tray 10 comprises a plurality of dis-associable portions, such as a plurality of segments. In one embodiment, each segment preferably defines a portion of the bottom 12 and rim 14 of the tray 10, so that when associated with one another, the segments form the entire tray 10.

In an embodiment where the tray 10 is square, the tray 10 may be comprised of four segments 16A, 16B, 16C and 16D. The segments 16A-D may be associated with one another to form the tray 10, or be disassociated from one another (such as illustrated in FIG. 4), thus allowing the tray 10 to be broken down into a smaller configuration, such as for shipping and storage. Further, this allows individual portions of the tray 10 to be removed and replaced, such as in the event of damage. This is distinct from known support assemblies (not shown), which are typically constructed as unitary and/or single components.

In the illustrated configuration, each tray segment 16A-D may comprise a quarter of the tray. In the illustrated configuration, each tray segment 16A-D encompasses one corner of the tray and a portion of the bottom 12 thereof. However, the tray 10 could comprise other numbers of segments, such as 6 or 8, including where segments define just portions of the sides and cooperate with others that define the corners, etc., or where portions are “pie” shaped, such as for cooperating to define a circular tray. A particular advantage of the embodiment illustrated in FIG. 4 is that, while comprising multiple segments 16A-D, the number and shape of the segments facilitate easy assembly by a user (as compared, for example, to configurations where greater numbers of segments might be used and the segments might be arranged in more than one potential configuration, thus requiring that the user ensure that the locations of the segments are correct before assembling them).

Details of the tray segments will be described with reference to FIGS. 5A and 5B, which illustrates one of the tray segments 16D, it being understood that in the preferred configuration, the other segments 16A-C are identical. As illustrated, the tray segment 16D defines a portion of the bottom 12 of the tray 10, and has a first side 20, a second side 22, a third side 24 and a fourth side 26. The third and fourth sides 24,26 preferably include a portion of the rim 14 of the tray 10, where the third and fourth sides 24,26 intersect to form one corner (an outer corner) of the tray 10.

In one embodiment, the first and second sides 20,22 extend outwardly to the third and fourth sides 24,26 and do not define portions of the rim 14. In one embodiment, the first and second sides 20,22 meet at and extend from an inner corner, at which is located an inset 28, which inset 28 may cooperate with the insets 28 in the other tray segments 16A-C to form an opening, such as a drain 30 (see FIGS. 3 and 4). In one embodiment, a lip 29 may extend downwardly below the bottom 12 of the tray segment 16D at the sides that define the inset 28.

In one embodiment, the rim 14 of the tray 10 may include an outwardly extending flange 32. The flange 32 may extend outwardly from the top of the rim 14, such as generally horizontally (e.g. generally parallel to the bottom 12 of the tray 14). As illustrated in FIGS. 5A and 5B, the sides of the tray segment 16D which define the rim 14 may also define corresponding portions of the flange 32.

In one embodiment, the tray segment 16D may define one or more supports 34 which extend upwardly from the bottom 12. Preferably, channels or troughs 36 extend or are located between the supports 34, which channels or troughs 36 are recessed relative to a top of the supports 34. In one embodiment, a grid of channels or troughs 36 may be provided, such as extending longitudinally and laterally. In one embodiment, at least one diagonal trough may extend from a corner of the tray segment 16D to the inset 28, with the lateral and longitudinal troughs leading to the diagonal trough. At least the diagonal trough may be sloped towards the inset 28, for reasons noted below.

In one embodiment, the tray segments 16A-D may be molded, including to define the rim 14, the supports 34 and the channels or troughs 36. In other embodiments, the channels or troughs 36 might be formed by removing material around the supports 34. The molding configuration has the advantage that it essentially creates a series of ribs on the bottom 12 of the tray, as best illustrated in FIG. 2. This aids in creating rigidity and strength to the tray.

As indicated above, the tray segments 16A-D may be associated with one another to define the tray 10. In one embodiment, the tray segments 16A-D may define an outwardly extending flange 38 along one side 20 (one of the sides without the rim 14) and a raised stop 40 along the adjacent side 40. The flange 38 is designed to slide under the raised stop 40 of an adjacent tray segment. In this configuration, the edges of the tray segments 16A-D effectively overlap one other.

In other embodiments, the tray segments 16A-D might simply be placed side-by-side or in adjacent positions. In yet other embodiments, the tray segments 16A-D might include means for releasably connecting them to one another, such as via mating locking tabs, interlocking channels, or even fasteners. An advantage of the preferred design is the simplicity of the tray segment 16A-D design for purposes of manufacturing, assembly and disassembly.

As illustrated in FIG. 1, when the tray segments 16A-D are associated with one another and form the complete tray 10, the tray defines a raised support surface comprised of the raised supports 34. Water may drain from the tray 10 through the channels or troughs 36 which lead to the drain 30 at the center of the tray 10.

Of course, the tray 10 might have other configurations. For example, each tray segment 16A-D might define its own drain.

The tray 10 may be used independently of the stand apparatus 110 which is described and illustrated herein. For example, the tray 10 could be placed on the floor, on a table or other structure. However, the tray 10 is advantageously used with the stand apparatus 110.

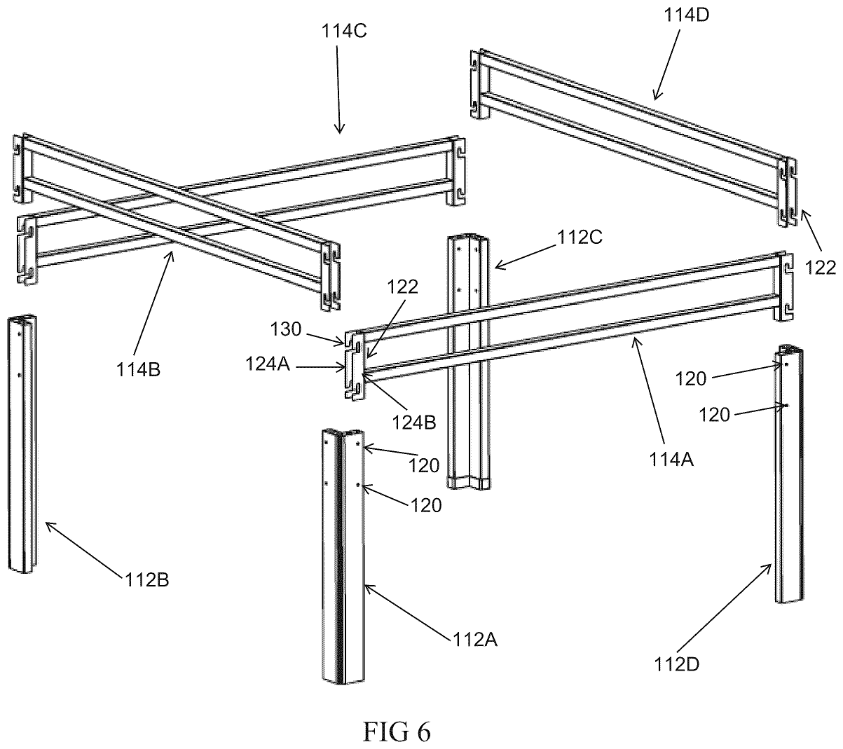

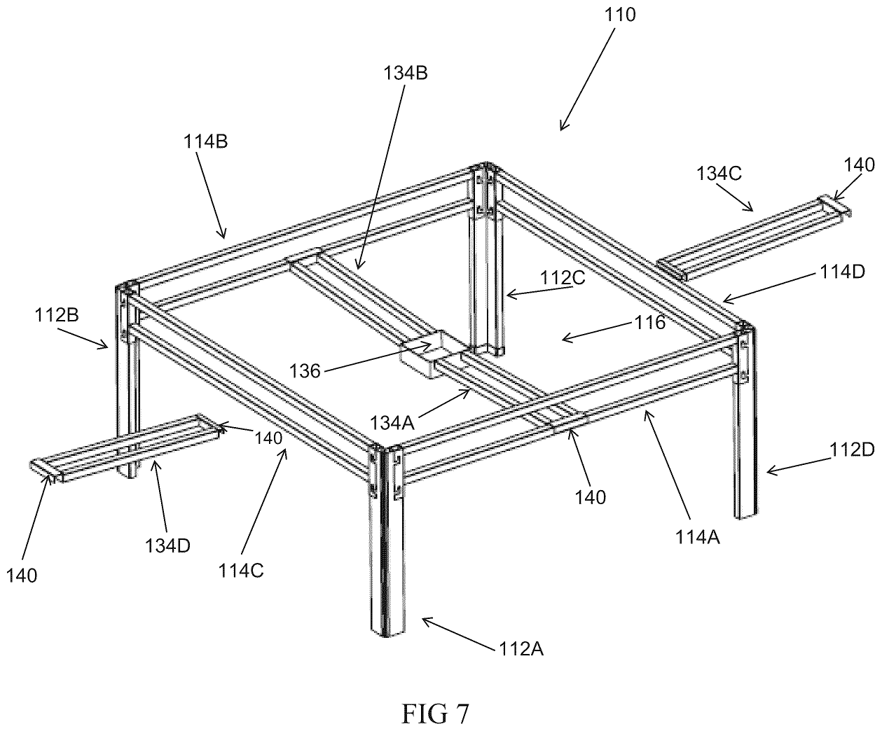

Reference will now be made to FIGS. 6 and 7, which illustrate the stand apparatus 110 in detail. As shown, the stand apparatus 110 preferably includes a plurality of legs 112A, 112B, 112C and 112D, a plurality of beams 114A, 114B, 114C and 114D, and a central support 116.

In one embodiment, the legs 112A-D each have a top and a bottom (such as for resting on a supporting surface, such as a floor), and are generally “C”-shaped in cross-section, having a first flange and a second flange which join perpendicular to one another. The beams 114A-D are configured to connected to and extend between pairs of the legs 112A-D.

In one embodiment, the beams 114A-D may comprise one or more longitudinal members which are connected to a mounting bracket 112 at each end, such as two members which are arranged vertically to create a lower or bottom member and a top or upper member.

In one embodiment, means are provided for releasably connecting the beams 114A-D to the legs 112A-D. In one embodiment, the legs 112A-D define outwardly extending tabs 120 on the flanges thereof, such as spaced from one another near the top of each leg. The tabs 120 may extend from both sides of each of the flanges. A mounting bracket 122 may be located at each end of each beam 114A-D. The mounting bracket 122 may be C-shaped, having a first leg 124A which is spaced from a second leg 124B. Slots 130 may be defined or provided in the first and second legs 124A, 124B, corresponding to the tabs 120 on the legs. The slots 130 may define an opening which extends transversely into the first or second legs 124A, 124B of the mounting bracket 122, to an upwardly extending slot. In use, the user may slide the mounting bracket 122 of one of the beams over the tabs 120 on each side of one of the legs (wherein the flange of the leg 112A-D is accepted between the first and second legs 124A, 124B of the bracket 122), through the aligned opening of the slots 130, and then lower the beam so that the tabs 120 are located at the top of the slots 130. In this configuration, gravity and weight of items placed on the beams 114A-D acts to press the beams downwardly, maintaining them in position on the legs 112A-D. Other means for releasably connecting might be used, such as where slots are formed in the legs 112A-D for accepting tabs 120 which are located on the beams 114A-D.

The legs 112A-D may be of various heights, such as depending upon the desired height of the stand apparatus 110. In some embodiments, the legs could be telescopic, such as to change the length thereof. In one embodiment, the tabs 120 are located so that when the beams 114A-D are connected thereto, a top of each beam 114A-D is located at the top of the legs 112A-D.

In one embodiment, the central support 116 comprises a central mount 132 and a plurality of cross-supports 134A, 134B, 134C and 134D. The central mount 132 may be generally square and define an opening 136 which aligns with the drain 30 of a tray 10 which is positioned thereon, where the downwardly extending lips 29 extend into the opening 136 of the central mount 132.

In one embodiment, the central mount 132 is four sided, and one cross-support 134A-D extends from each side of the central mount 132 to the beam 114A-D which is located adjacent thereto. The cross-supports 134A-D may be connected to the central mount 132 and the beams 114A-D in various manners, such as by using fasteners, mounting elements, or the like. In one embodiment, two of the cross-supports 134A and 134B are permanently affixed to the central mount 132 and extend in opposing directions therefrom. These cross-supports 134A and 134B may define an inverted C or U-shaped flange 140 at the opposing end thereof for location over a portion of the associated beam 114A-D, such as the lower support of each of the beams. The other cross-supports 134C and 134D may each have such a flange 140 at both ends, one for connection to the central mount 132 and one for connection to the corresponding beam 114C, and 114D.

So configured, the stand apparatus 110 can be assembled by a user without tools, simply by interconnecting the elements thereof. Further, a user can disassemble the stand apparatus 110 without a tool. In addition, the user can replace individual elements of the stand apparatus 110, such as in the event of damage.

In addition, when the stand apparatus 110 is disassembled, all of the elements thereof can be aligned parallel to one another, wherein the widest dimension of the elements are the beams 114A-D and the cross-beams 134A-D. This allows the stand apparatus 110 to be broken down for shipment and storage in a small package, reducing the associated cost thereof, particularly in relation to stands which can't be disassembled.

As best illustrated in FIGS. 1 and 2, when the tray 10 is placed on the stand apparatus 110, the bottom of the tray 10 is supported by the central support 116. In a preferred embodiment, the stand apparatus 110 is configured to that the distance between the central support 116 and the top of the beams 114A-D (and thus the distance between the lower member and upper member of each beam) is slightly less than the height of the tray 10, whereby when the tray 10 is supported on the stand, the flange 32 which extends outwardly from the rim 14 of the tray 10 extends over the tops of the beams 114A-D (such as the upper elongate members), so as to be supported thereby.

In the illustrated embodiment, the stand apparatus 110 (when assembled) has a peripheral shape which is generally the same as the tray 10 and is thus generally square. However, the stand apparatus 110 might have other shapes, such as rectangular, to support a corresponding rectangularly-shaped tray 10. In such a configuration, the stand apparatus 110 might include more than four legs and might include additional beams extending between the additional legs.

Also, while in one embodiment the beams 114A-D are mounted at the tops of the legs 112A-D, the beams might be configured to be mounted at different heights along the legs. In one embodiment, the outer corners of the tray segments 16A-D might be notched so as to permit the legs 112A-D of the stand apparatus 110 to extend upwardly beyond the tray 10.

It will be understood that the above-described arrangements of apparatus and the method there from are merely illustrative of applications of the principles of this invention and many other embodiments and modifications may be made without departing from the spirit and scope of the invention as defined in the claims.

What is claimed is:

1. A grow tray for supporting one or more plants, the tray having a bottom, an upwardly extending peripheral rim, and at least one drain through said bottom, comprising:
a plurality of associable tray segments, each tray segment defining a portion of said bottom of said tray and having at least one side defining a portion of said upwardly extending peripheral rim, a plurality of supports extending upwardly from said bottom, and one or more channels defined between said supports.

2. The grow tray in accordance with claim 1, wherein said tray comprises four tray segments, each having four sides, wherein first and second sides define portions of said upwardly extending peripheral rim of said tray, and each tray segment defining an inset which cooperates with the insets of the other trays to define said drain.

3. The grow tray in accordance with claim 2, wherein each tray segment defines at least a portion of a downwardly extending flange of said drain.

4. The grow tray in accordance with claim 1, wherein said one or more channels comprise at least one first channel, at least one second channel extending orthogonal to the at least one first channel, and at least one third channel extending diagonally to said at least one first and at least one second channel.

5. The grow tray in accordance with claim 4, wherein said least one third channel extends to said at least one drain.

6. The grow tray in accordance with claim 2, wherein a third side of each tray defines an outwardly extending flange and a fourth side of each tray defines a stop, said third side of one tray configured to be positioned against the fourth side of an adjacent tray.

7. The grow tray in accordance with claim 1, wherein a flange extending outwardly from a top of said rim.

8. The grow tray in accordance with claim 1 wherein said four tray segments are identical.

9. A stand assembly for supporting a grow tray comprising:
a plurality of legs, each leg having a top and a bottom;
a plurality of beams, each beam configured to be detachably mounted to pairs of the plurality of legs; and
a central support, said central support comprising a central mount and one or more cross-supports extending between the central mount and an adjacent beam for supporting the central mount in a raised position above the bottoms of the legs.

10. The stand assembly in accordance with claim 9, wherein a top of each beam is located in the same plane as the top of each of said plurality of legs when connected thereto.

11. The stand assembly in accordance with claim 9, comprising four legs and four beams.

12. The stand assembly in accordance with claim 9, wherein each of said plurality of beams has a first end and a second end and a middle, said cross-supports extending inwardly from the middle of each beam.

13. The stand assembly in accordance with claim 9, wherein said central mount has a central opening therein for alignment with a drain of said grow tray.

14. In combination, a grow tray and a grow tray stand, comprising:
said grow tray stand comprising:
a plurality of legs, each leg having a top and a bottom;
a plurality of beams, each beam configured to be detachably mounted to pairs of the plurality of legs; and
a central support, said central support comprising a central mount and one or more cross-supports extending between the central mount and an adjacent beam for supporting the central mount in a raised position above the bottoms of the legs;
and
said grow tray having a bottom, an upwardly extending peripheral rim, and at least one drain through said bottom and comprising a plurality of associable tray segments, each tray segment defining a portion of said bottom of said tray and having at least one side defining a portion of said upwardly extending peripheral rim, a plurality of supports extending upwardly from said bottom, and one or more channels defined between said supports.

15. The combination in accordance with claim 14, wherein said at least one drain is assigned with an opening through said central support when said grow tray is located on said grow tray stand.

16. The combination in accordance with claim 14, wherein said grow tray further comprises a flange extending outwardly from at least a portion of said peripheral rim, said flange positioned on a top of said plurality of legs and/or plurality of beams when said grow tray is located on said grow tray stand.

17. The combination in accordance with claim 14, wherein said grow tray stand is quadrilateral shaped when assembled, comprising four legs and four beams, and wherein said grow tray is quadrilateral shaped and comprises four segments.

18. The combination in accordance with claim 17, wherein each of said four legs, each of said four beams and each of said four grow tray segments are identical.
